(19) United States
(12) Patent Application Publication
(10) Pub. No.: US 2022/0405174 A1
(43) Pub. Date: Dec. 22, 2022

(54) METHOD, DEVICE, AND PROGRAM PRODUCT FOR MANAGING DATA BACKUP

(71) Applicant: EMC IP Holding Company LLC, Hopkinton, MA (US)

(72) Inventor: Bo Liu, Chengdu (CN)

(21) Appl. No.: 17/556,113

(22) Filed: Dec. 20, 2021

(30) Foreign Application Priority Data
Jun. 16, 2021 (CN) 202110664991.3

(51) Int. Cl. G06F 11/14

(52) U.S. Cl. CPC G06F 11/1461; G06F 11/1466; G06F 11/1464

(57) ABSTRACT

According to certain disclosed techniques, tolerance time lengths respectively associated with backup sessions are acquired, wherein a tolerance time length represents the length of time in which data loss is tolerated during a failure of a source storage device associated with a backup session of the plurality of backup sessions. A backup period for performing the backup sessions is determined based on the tolerance time lengths. The backup period is divided into time slices based on a predetermined time interval. At least one time slice is allocated to the backup session based on the tolerance time length. Accordingly, it is possible to ensure that corresponding time slices allocated for each backup session are distributed as evenly as possible throughout the time of day, thus ensuring load balancing of the backup system.

### CROSS-REFERENCE TO RELATED APPLICATION

This application claims priority to Chinese Patent Application No. CN202110664991.3, on file at the China National Intellectual Property Administration (CNIPA), having a filing date of Jun. 16, 2021, and having “METHOD, DEVICE, AND PROGRAM PRODUCT FOR MANAGING DATA BACKUP” as a title, the contents and teachings of which are herein incorporated by reference in their entirety.

### TECHNICAL FIELD

Implementations of the present disclosure relate to data backups and, more specifically, to a method, a device, and a computer program product for managing time allocation in a backup system.

### BACKGROUND

With the development of storage technology, many types of storage devices have been widely used in a variety of application environments. For example, in a banking environment, storage devices can be used to store account information about individual users; in a sales environment, storage devices can be used to store sales data about various products, and so on. In order to avoid unrecoverable failures in a storage device, backup sessions can be used to periodically back up data from various application systems to a backup system. However, if a large number of backup sessions occur in the same period of time, the workload of the backup system will be too high, which may lead to long response time or even failures such as downtime. At this point, how to manage data backups more effectively becomes a hot research topic.

### SUMMARY OF THE INVENTION

Therefore, it is desirable to develop and implement a technical solution for managing data backups in a more effective manner. It is desired that this technical solution can manage data backups in a more convenient and effective way, and thus improve the performance of backup systems.

According to a first aspect of the present disclosure, a method for managing data backups is provided. In this method, a plurality of tolerance time lengths respectively associated with a plurality of backup sessions are acquired, wherein a tolerance time length of the plurality of tolerance time lengths represents the length of time in which data loss is tolerated during a failure of a source storage device associated with a backup session of the plurality of backup sessions. A backup period for performing the plurality of backup sessions is determined based on the plurality of tolerance time lengths. The backup period is divided into a plurality of time slices based on a predetermined time interval. At least one time slice of the plurality of time slices is allocated to the backup session based on the tolerance time length.

According to a second aspect of the present disclosure, an electronic device is provided, including: at least one processor; a volatile memory; and a memory coupled to the at least one processor, wherein the memory has instructions stored therein which, when executed by the at least one processor, cause the device to perform the method according to the first aspect of the present disclosure.

According to a third aspect of the present disclosure, a computer program product is provided. The computer program product is tangibly stored on a non-transitory computer-readable medium and contains machine-executable instructions for performing the method according to the first aspect of the present disclosure.

### BRIEF DESCRIPTION OF THE DRAWINGS

In combination with the accompanying drawings and with reference to the following detailed description, the features, advantages, and other aspects of the implementations of the present disclosure will become more apparent, and several implementations of the present disclosure are illustrated here by way of examples rather than limitation. In the accompanying drawings,

FIG. 1 schematically illustrates a block diagram of an application environment in which example implementations of the present disclosure may be implemented;

FIG. 2 schematically illustrates a block diagram for managing time slices of data backups according to an example implementation of the present disclosure;

FIG. 3 schematically illustrates a flow chart of a method for managing data backups according to an example implementation of the present disclosure;

FIG. 4 schematically illustrates a block diagram of a tolerance time length according to an example implementation of the present disclosure;

FIG. 5 schematically illustrates a block diagram of a process for allocating time slices according to an example implementation of the present disclosure;

FIG. 6 schematically illustrates a block diagram of a data structure for storing the states of time slices according to an example implementation of the present disclosure; and

FIG. 7 schematically illustrates a block diagram of a device for managing data backups according to an example implementation of the present disclosure.

### DETAILED DESCRIPTION

The individual features of the various embodiments, examples, and implementations disclosed within this document can be combined in any desired manner that makes technological sense. Furthermore, the individual features are hereby combined in this manner to form all possible combinations, permutations and variants except to the extent that such combinations, permutations and/or variants have been explicitly excluded or are impractical. Support for such combinations, permutations and variants is considered to exist within this document.

It should be understood that the specialized circuitry that performs one or more of the various operations disclosed herein may be formed by one or more processors operating in accordance with specialized instructions persistently stored in memory. Such components may be arranged in a variety of ways such as tightly coupled with each other (e.g., where the components electronically communicate over a computer bus), distributed among different locations (e.g., where the components electronically communicate over a computer network), combinations thereof, and so on.

Preferred implementations of the present disclosure will now be described in more detail below with reference to the accompanying drawings. Although the preferred implementations of the present disclosure are illustrated in the accompanying drawings, it should be understood that the present disclosure may be implemented in various forms and should not be limited by the implementations illustrated herein. Instead, these implementations are provided in order to make the present disclosure more thorough and complete, and to fully convey the scope of the present disclosure to those skilled in the art.

The term “include” and variants thereof used herein indicate open-ended inclusion, that is, “including but not limited to.” Unless specifically stated, the term “or” means “and/or.” The term “based on” means “based at least in part on.” The terms “one exemplary embodiment” and “one embodiment” mean “at least one exemplary embodiment.” The term “another implementation” means “at least one additional implementation.” The terms “first,” “second,” and the like may refer to different or identical objects. Other explicit and implicit definitions may also be included below.

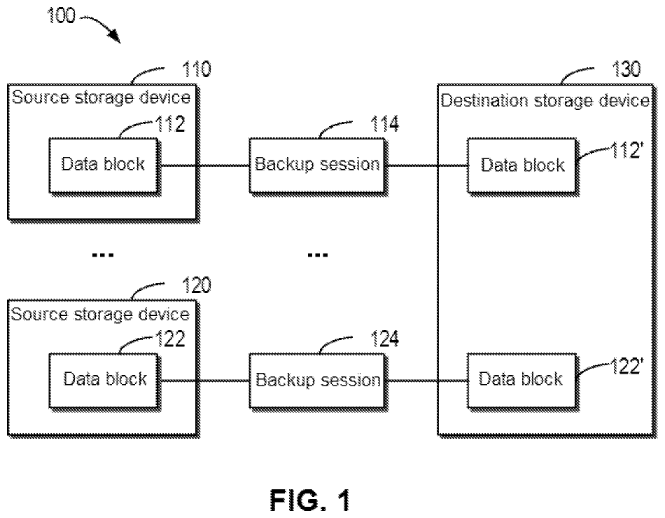

For ease of description, an application environment according to an example implementation of the present disclosure will be first described with reference to FIG. 1. FIG. 1 schematically illustrates a block diagram of application environment 100 in which example implementations of the present disclosure may be implemented. As shown in FIG. 1, application environment 100 may include source storage devices 110, . . . , and 120, and destination storage device 130. Here, the destination storage device acts as a backup destination in the backup system and can store data blocks from various source storage devices. For example, backup session 114 can back up data block 112 from source storage device 110 to destination storage device 130 to form data block 112′, and backup session 124 can back up data block 122 from source storage device 120 to destination storage device 130 to form data block 122′. Backup sessions can be used to periodically perform backup operations to ensure that data blocks respectively backed up at a plurality of time points are included in destination storage device 130.

It will be understood that destination storage device 130 has limitations on various resources (e.g., bandwidth resources, computing resources, etc.), and if a large number of backup sessions occur concurrently in a short period of time, this will result in a shortage of resources in destination storage device 130, which in turn will cause the backup process to be interrupted, thereby increasing the risk of data loss in the source storage device. At present, technical solutions have been proposed for scheduling a plurality of backup sessions based on the workload of destination storage device 130. However, the existing technical solutions cannot ensure that the plurality of backup sessions are evenly distributed throughout the time of day. Thus, it is expected that a technical solution for automatically allocating time slices for a plurality of backup sessions can be provided, and it is expected that this technical solution can be compatible with the existing backup systems, thus improving the overall performance of the backup systems.

In order to at least partially eliminate the shortcomings in the above technical solutions, according to an example implementation of the present disclosure, a method for managing data backups is provided. In this method, a day can be divided into a plurality of time slices. Further, a plurality of backup sessions can be allocated corresponding time slices so that the plurality of backup sessions can be evenly distributed throughout the time of day.

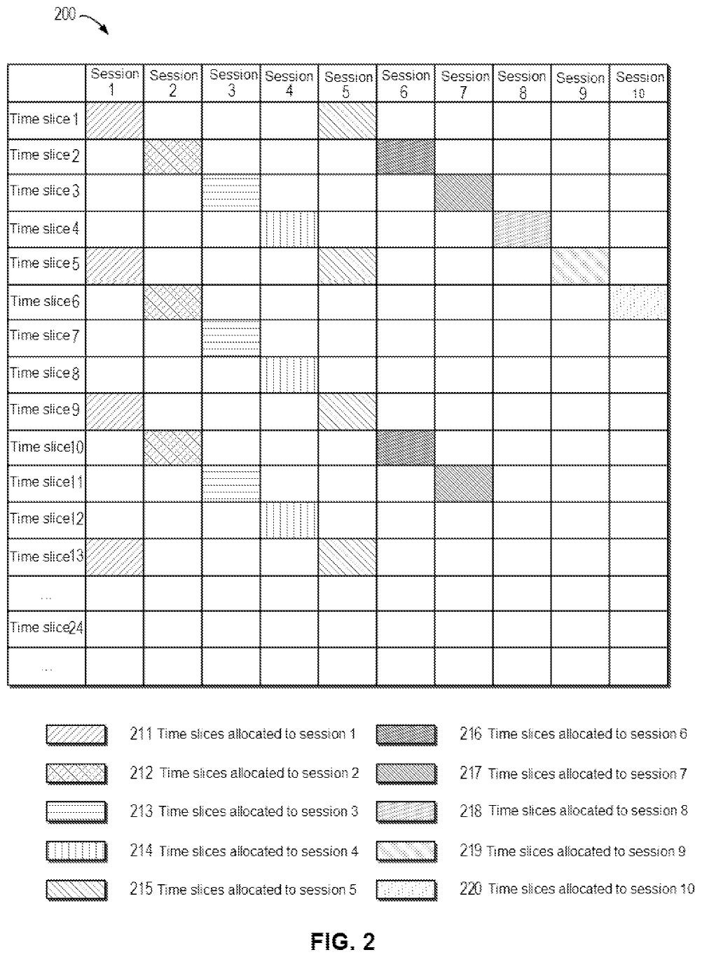

Hereinafter, an overview of an example implementation according to the present disclosure will be described with reference to FIG. 2. FIG. 2 schematically illustrates block diagram 200 for managing time slices of data backups according to an example implementation of the present disclosure. As shown in FIG. 2, assuming that there exist 10 backup sessions (labeled session 1 to session 10, respectively), a day can be divided into a plurality of time slices: time slice 1, time slice 2, . . . , time slice 24, etc. Each session can be allocated corresponding time slices, respectively, according to the tolerance time length for each backup session. Specifically, legends 211 to 220 respectively show the time slices allocated to sessions 1 to 10. For example, session 1 can be allocated time slices 1, 5, 9, 13 . . . , session 2 can be allocated time slices 2, 6, 10 . . . , session 3 can be allocated time slices 3, 7, 11 . . . , and so on. In this way, it can be ensured that the execution time of the plurality of sessions is distributed as evenly as possible throughout the time of day, thus achieving load balancing of the backup system.

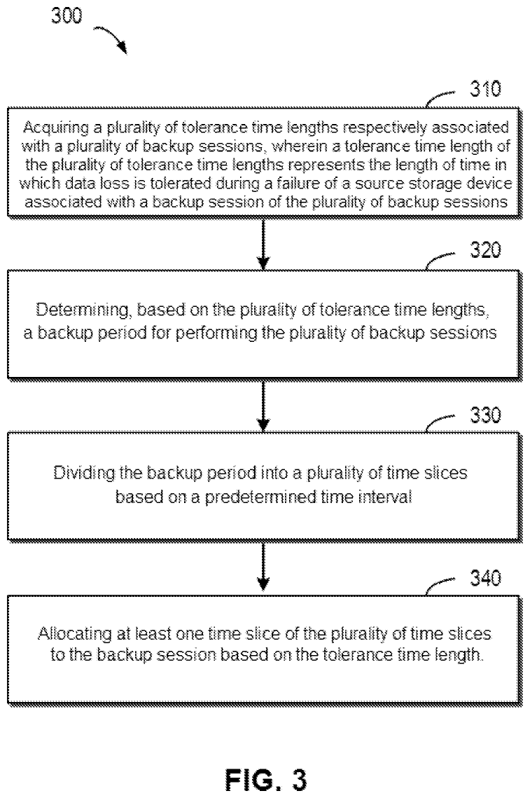

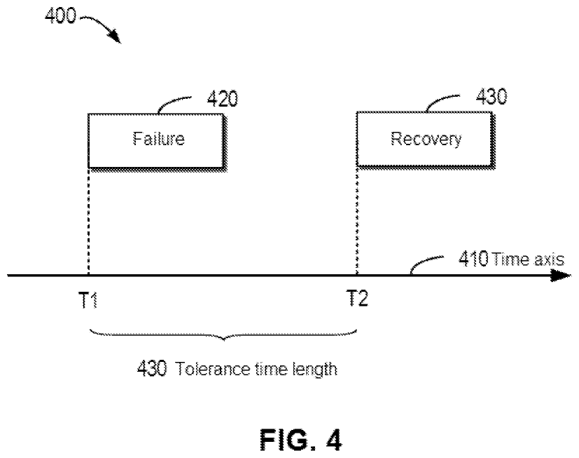

Hereinafter, more details of an example implementation according to the present disclosure will be described with reference to FIG. 3. FIG. 3 schematically illustrates a flow chart of method 300 for managing data backups according to an example implementation of the present disclosure. At block 310, a plurality of tolerance time lengths respectively associated with a plurality of backup sessions are acquired. In the context of the present disclosure, each backup session can have a corresponding tolerance time length, wherein the tolerance time length may represent the length of time in which data loss is tolerated during a failure of a source storage device associated with the backup session. Hereinafter, more details about the tolerance time length are described with reference to FIG. 4.

FIG. 4 schematically illustrates block diagram 400 of a tolerance time length according to an example implementation of the present disclosure. In the context of the present disclosure, the tolerance time length is associated with a failure in the source storage device from which the backup session reads data. The tolerance time length can be expressed, for example, using the Recovery Point Objective (RPO). Here, RPO describes the threshold of time in which data may be lost during a failure of the source storage device, and the amount of data lost during this period exceeds the maximum threshold allowed by the storage rules. FIG. 4 illustrates time axis 410, wherein time point T1 indicates the time point at which failure 420 occurs in the source storage device, and time point T2 indicates the threshold time point at which the source storage device is expected to recover from the failure. The time length between time points T1 and T2 represents the tolerance time length of the source storage device.

It will be understood that if the source storage device has a failure, data newly generated before the source storage device is recovered (i.e., during the time period T2-T1) may be lost. Thus, the tolerance time length is associated with the amount of data allowed to be lost. Different source storage devices may have different tolerance time lengths. For example, the tolerance time length associated with a source storage device serving a banking system can be small (e.g., 5 minutes). This means that the failure should be tolerated for a maximum of 5 minutes, i.e., the failure should be eliminated within 5 minutes. For another example, the tolerance time length associated with a source storage device serving a sales system can be high (e.g., 1 hour).

According to an example implementation of the present disclosure, the tolerance time length associated with each session can be determined respectively. For the 10 sessions as shown in FIG. 2, sessions 1 to 5 have a tolerance time length of 1 hour, sessions 6 to 7 have a tolerance time length of 2 hours, sessions 8 to 9 have a tolerance time length of 3 hours, and session 10 has a tolerance time length of 6 hours.

Returning to FIG. 3, at block 320 of FIG. 3, the backup period used to perform the plurality of backup sessions is determined based on the plurality of tolerance time lengths. The backup period is the period in which at least one backup operation is performed for all of the plurality of backup sessions. According to an example implementation of the present disclosure, the backup period can be determined based on a common multiple of the plurality of tolerance time lengths. In the example above, the least common multiple of the plurality of tolerance time lengths of 1 hour, 2 hours, 3 hours, and 6 hours is 6, and thus the backup period can be determined to be 6 hours. According to an example implementation of the present disclosure, the backup period can also be determined as, for example, 12 hours or other common multiples.

At block 330, the backup period can be divided into a plurality of time slices based on a predetermined time interval. The time interval here is the length of time to perform a backup session. For example, the lengths of time slices 1 to 24, etc. in FIG. 2 can be the same. The time interval can be determined in a variety of ways, for example, the time interval can be set to a predetermined value, such as 5 minutes, 10 minutes, 15 minutes, or other values. It will be understood that the length of time to perform a given backup session should be no greater than the associated tolerance time length for that backup session, otherwise it will not be possible to complete the given backup session in the desired time. According to an example implementation of the present disclosure, the time interval can be determined based on the minimum value of the plurality of tolerance time lengths. For example, the time interval can be set to 1/n of this minimum value (n is a positive integer).

According to an example implementation of the present disclosure, the time interval can be set based on the number of the plurality of backup sessions. If there are a large number of backup sessions, the time interval can be set to a small value in order to serve a large number of backup sessions at a higher granularity. If the number of backup sessions is small, the time interval can be set to a large value. According to an example implementation of the present disclosure, the time interval can be set based on the amount of backup data involved in the plurality of backup sessions. If the backup session involves a large amount of backup data and it takes a long time to perform the backup session, the time interval can be set to a large value; and if the backup session involves a small amount of backup data and it takes a short time to perform the backup session, the time interval can be set to a small value. In this way, it can be ensured that the backup session is completed within the allocated time slices.

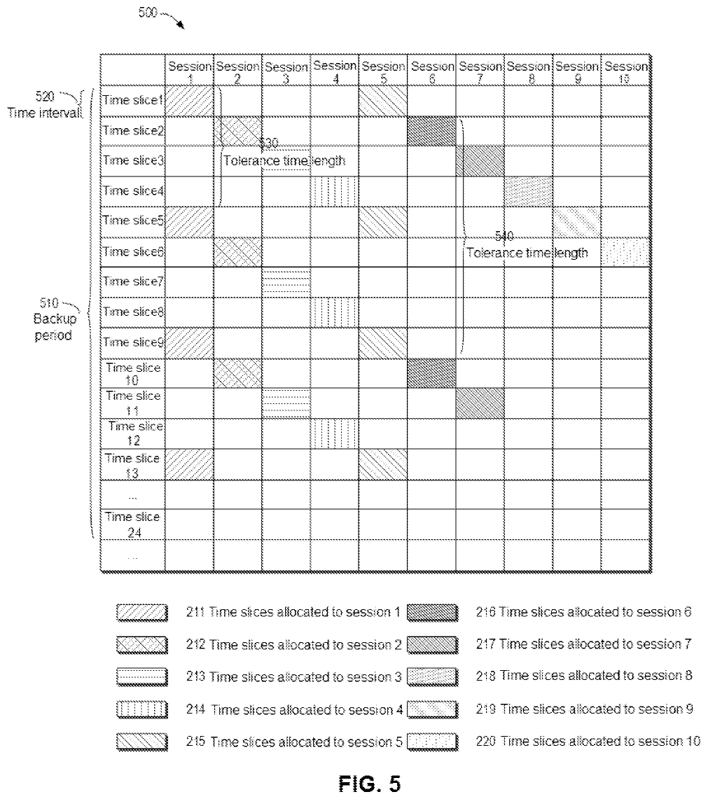

After the time interval has been determined, the backup period can be divided into a plurality of time slices according to that time interval. Hereinafter, more details about division of time slices are described with reference to FIG. 5. FIG. 5 schematically illustrates a block diagram of process 500 for allocating time slices according to an example implementation of the present disclosure. As shown in FIG. 5, time interval 520 represents the predetermined length of the time slice. Assuming that the time interval is 15 minutes and backup period 510 is 6 hours, backup period 510 can be divided into 24 time slices.

More details about allocating time slices will be described by returning to FIG. 3. At block 340 of FIG. 3, at least one time slice of the plurality of time slices is allocated to the backup session based on the tolerance time length. Based on the tolerance time length for each backup session, a corresponding number of time slices can be allocated to each backup session. Referring to FIG. 5, the tolerance time length 530 of session 1 is 1 hour and 6/1=6 time slices can be allocated for backup session 1: time slices 1, 5, 9, 13, 17, and 21. Since the tolerance time length for sessions 2 to 5 are all 1 hour, 6 time slices can be allocated to each session respectively.

According to an example implementation of the present disclosure, one or more time slices can be allocated to each of the plurality of backup sessions during the backup period based on the allocation state of the plurality of time slices. All the backup sessions can be processed one by one, and hereinafter, backup session 1 will be described as an example. In the initial phase, all time slices are unallocated and a time slice (e.g., time slice 1) can be randomly selected to be allocated to backup session 1. Following that, the number of time slices allocated to a backup session during a backup period can be determined based on the following Equation 1:

Number of time slices=backup period/tolerance time length. Equation 1

In this case, a plurality of time slices are allocated to a backup session if the backup period is greater than the tolerance time length of the backup session, otherwise only one time slice is allocated to the backup session. According to an example implementation of the present disclosure, a second time slice of the plurality of time slices can be allocated to the backup session during the backup period based on the allocation state of the plurality of time slices. Here, the difference between the first time slice and the second time slice is no greater than the tolerance time length in order to ensure that the next backup is performed within the tolerance time length. In order to utilize each time slice as fully as possible, the time slice that follows the first time slice and has a distance of the tolerance time length from the first time slice can be selected as the second time slice. For example, time slice 5 after time slice 1 can be selected and time slice 5 can be allocated to backup session 1. Further, time slices 9, 13, 17, and 21 after time slice 5 can be selected. At this point, a total of 6 time slices are allocated to backup session 1: time slices 1, 5, 9, 13, 17, and 21.

Other backup sessions can be processed in a similar way. Time slices that have not yet been allocated can be allocated preferentially. Specifically, if it is determined that the allocation state indicates that a given time slice of the plurality of time slices has not yet been allocated, that given time slice is selected for allocation. For example, time slices 2, 6, 10, 14, 18, and 22 can be selected and allocated for session 2, time slices 3, 7, 11, 15, 19, and 23 can be allocated for session 3, and time slices 4, 8, 12, 16, 20, and 24 can be allocated for session 4. At this point, all 24 time slices have been allocated, and the number of allocations for each time slice is 1.

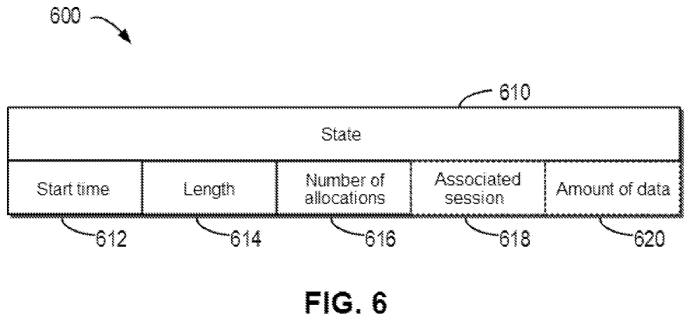

According to an example implementation of the present disclosure, the state of each time slice can be stored. Hereinafter, more details are described with reference to FIG. 6. This FIG. 6 schematically illustrates a block diagram of data structure 600 for storing the states of time slices according to an example implementation of the present disclosure. In FIG. 6, state 610 of the time slice may include a plurality of fields: field 612 is used to indicate the start time (e.g., 00:00:00) of the time slice, field 614 is used to indicate the length (e.g., 15 minutes) of the time slice, and field 616 is used to indicate the number of allocations (e.g., 0 times, 1 time, etc.) for that time slice. When selecting time slices, time slices that are allocated a lower number of times can be selected preferentially to ensure load balancing of the backup system.

Returning to FIG. 5, at this point, the number of allocations for each of the 24 time slices is 1, and thus the time slices that will be allocated to backup session 5 can be randomly selected. For example, time slice 1 can be selected as the first time slice allocated to backup session 5 and subsequent time slices 5, 9, 13, 17, and 21 can be selected according to the tolerance time length of backup session 5. Other backup sessions 6 to 10 can be processed in a similar way. For example, backup session 6 has a tolerance time length 540 of 2 hours, and thus time slices 2, 10, and 18 can be allocated to backup session 6. Based on the tolerance time length for each session, time slices 2, 11, and 19 can be allocated to backup session 7, time slices 3 and 17 can be allocated to backup session 8, time slices 4 and 17 can be allocated to backup session 9, and time slice 5 can be allocated to backup session 10.

According to an example implementation of the present disclosure, state 610 can further include: field 618 used to indicate which backup session(s) that time slice is allocated to and field 620 used to indicate the amount of backup data involved in the associated session. The amount of backup data can indicate the amount of data that needs to be transferred during that time slice, and thus time slices with smaller amounts of backup data can be selected preferentially. With the example implementation of the present disclosure, load balancing of the backup system can be further achieved with greater accuracy based on the amount of data in the backup operation.

According to an example implementation of the present disclosure, the backup session can be executed only within the allocated time slices, and the backup session can be stopped outside the allocated time slices. For example, backup session 1 is executed only within time slices 1, 5, 9, 13, 17, and 21, and the backup session is not executed during the other time periods. According to an example implementation of the present disclosure, the time slices of the day can be processed according to the method described above. For example, 24 hours of the day can include 24/6=4 backup periods. In this case, the work time of backup sessions 1 to 10 will be evenly distributed throughout the day, thus ensuring load balancing of the backup system.

During the operation of the backup system, new backup sessions may appear and the existing backup sessions may be terminated, so the time slice allocation scheme needs to be adjusted accordingly. According to an example implementation of the present disclosure, if a new backup session is detected in the backup system, a tolerance time length associated with the new backup session may be determined. Following that, one or more of the plurality of time slices can be allocated to the new backup session based on that tolerance time length.

According to an example implementation of the present disclosure, if the current backup period is an integer multiple of the tolerance time length of the new backup session, the time slices with low workloads can be selected preferentially from the plurality of time slices. Assuming that a new backup session 11 is detected and the associated tolerance time length is 3 hours, time slices 1 and 13 can be selected for allocation to backup session 11. According to an example implementation of the present disclosure, the method described above may be re-executed if the current backup period is not an integer multiple of the tolerance time length of backup session 11. In other words, the backup period can be redetermined based on the least common multiple of the tolerance time lengths of backup sessions 1 to 11, and then the subsequent operations can be performed.

According to an example implementation of the present disclosure, if it is determined that the backup session is terminated, at least one time slice allocated to the backup session can be released. Specifically, the information about the data structure as shown in FIG. 6 can be modified, for example, by subtracting one from the number of allocations 618, removing the terminated backup session from the associated session 618, and removing the amount of data generated by the terminated backup session from data stream 620. With the example implementation of the present disclosure, the state information of each time slice can be made more consistent with the real operating state, which in turn facilitates time slice allocation. According to an example implementation of the present disclosure, time slices can be reallocated to individual backup sessions based on the updated states of the individual time slices. With the example implementation of the present disclosure, the time slices of the backup system can be dynamically scheduled as the number of backup sessions in the backup system changes, thereby improving the overall performance of the backup system.

Examples of the method according to the present disclosure have been described in detail above with reference to FIGS. 2 to 6, and implementations of a corresponding apparatus will be described below. According to an example implementation of the present disclosure, an apparatus for managing data backups is provided. This apparatus includes: an acquiring module configured to acquire a plurality of tolerance time lengths respectively associated with a plurality of backup sessions, wherein a tolerance time length of the plurality of tolerance time lengths represents the length of time in which data loss is tolerated during a failure of a source storage device associated with a backup session of the plurality of backup sessions; a determining module configured to determine, based on the plurality of tolerance time lengths, a backup period for performing the plurality of backup sessions; a dividing module configured to divide the backup period into a plurality of time slices based on a predetermined time interval; and an allocating module configured to allocate at least one time slice of the plurality of time slices to the backup session based on the tolerance time length. According to an example implementation of the present disclosure, this apparatus further includes modules for performing other steps in method 300 described above.

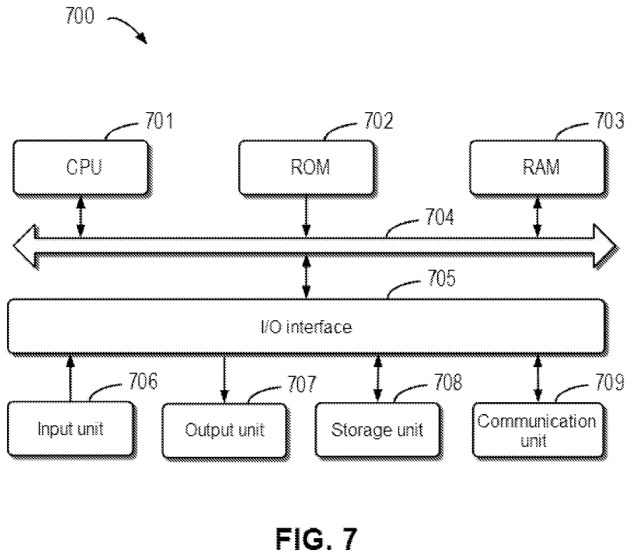

FIG. 7 schematically illustrates a block diagram of device 700 for managing data backups according to an example implementation of the present disclosure. As shown in the figure, device 700 includes central processing unit (CPU) 701 that may execute various appropriate actions and processing according to computer program instructions stored in read-only memory (ROM) 702 or computer program instructions loaded from storage unit 708 into random access memory (RAM) 703. In RAM 703, various programs and data required for the operation of storage device 700 may also be stored. CPU 701, ROM 702, and RAM 703 are connected to one another through bus 704. Input/output (I/O) interface 705 is also connected to bus 704.

A plurality of components in device 700 are connected to I/O interface 705, including: input unit 706, such as a keyboard and a mouse; output unit 707, such as various types of displays and speakers; storage unit 708, such as a magnetic disk and an optical disc; and communication unit 709, such as a network card, a modem, and a wireless communication transceiver. Communication unit 709 allows device 700 to exchange information/data with other devices via a computer network, such as the Internet, and/or various telecommunication networks.

The various processes and processing described above, such as method 300, may be performed by processing unit 701. For example, in some implementations, method 300 may be implemented as a computer software program that is tangibly included in a machine-readable medium, such as storage unit 708. In some implementations, part or all of the computer program may be loaded and/or installed onto device 700 via ROM 702 and/or communication unit 709. One or more steps of method 300 described above may be performed when the computer program is loaded into RAM 703 and executed by CPU 701. Alternatively, in other implementations, CPU 701 may also be configured in any other suitable manner to implement the above processes/methods.

According to an example implementation of the present disclosure, an electronic device is provided, including: at least one processor; a volatile memory; and a memory coupled to the at least one processor, wherein the memory has instructions stored therein which, when executed by the at least one processor, cause the device to perform a method for managing data backups. This method includes: acquiring a plurality of tolerance time lengths respectively associated with a plurality of backup sessions, wherein a tolerance time length of the plurality of tolerance time lengths represents the length of time in which data loss is tolerated during a failure of a source storage device associated with a backup session of the plurality of backup sessions; determining, based on the plurality of tolerance time lengths, a backup period for performing the plurality of backup sessions; dividing the backup period into a plurality of time slices based on a predetermined time interval; and allocating at least one time slice of the plurality of time slices to the backup session based on the tolerance time length.

According to an example implementation of the present disclosure, allocating the at least one time slice of the plurality of time slices to the backup session includes: allocating a first time slice of the plurality of time slices to the backup session during the backup period based on an allocation state of the plurality of time slices.

According to an example implementation of the present disclosure, allocating the first time slice to the backup session includes selecting the first time slice based on at least any one of: in response to determining that the allocation state indicates that a given time slice of the plurality of time slices has not yet been allocated, selecting the given time slice as first time slice; and in response to determining that the allocation state indicates that all of the plurality of time slices have been allocated, selecting the first time slice from the plurality of time slices based on the numbers of times the plurality of time slices have been allocated.

According to an example implementation of the present disclosure, allocating the at least one time slice of the plurality of time slices to the backup session further includes: in response to determining that the backup period is greater than the tolerance time length of the backup session, allocating a second time slice of the plurality of time slices to the backup session during the backup period based on the allocation state of the plurality of time slices, the difference between the first time slice and the second time slice being no greater than the tolerance time length.

According to an example implementation of the present disclosure, the time interval is determined based on at least any one of: the minimum value of the plurality of tolerance time lengths; the number of the plurality of backup sessions; and the amount of backup data involved in the plurality of backup sessions.

According to an example implementation of the present disclosure, determining the backup period includes: determining the backup period based on a common multiple of the plurality of tolerance time lengths.

According to an example implementation of the present disclosure, the method further includes: in response to determining that the backup period is a multiple of another tolerance time length associated with another backup session in the backup system, determining the another tolerance time length associated with the another backup session; and allocating at least one other time slice of the plurality of time slices to the another backup session based on the another tolerance time length.

According to an example implementation of the present disclosure, the method further includes: updating, in response to determining that the backup period is not a multiple of the another tolerance time length, the backup period based on the plurality of tolerance time lengths and the another tolerance time length; dividing the updated backup period into a plurality of time slices based on the time interval; and allocating at least one time slice of the plurality of time slices to the plurality of backup sessions and the another backup session, respectively, based on the plurality of tolerance time lengths and the another tolerance time length.

According to an example implementation of the present disclosure, the method further includes: in response to determining that the backup session is terminated, releasing the at least one time slice that is allocated to the backup session.

According to an example implementation of the present disclosure, the method further includes at least any one of: within the at least one time slice, performing the backup session; and outside the at least one time slice, stopping the backup session.

According to an example implementation of the present disclosure, a computer program product is provided, which is tangibly stored on a non-transitory computer-readable medium and includes machine-executable instructions, wherein the machine-executable instructions are used to perform the method according to the present disclosure.

According to an example implementation of the present disclosure, a computer-readable medium is provided, the computer-readable medium storing machine-executable instructions which, when being executed by at least one processor, cause the at least one processor to implement the method according to the present disclosure.

The present disclosure may be a method, a device, a system, and/or a computer program product. The computer program product may include a computer-readable storage medium on which computer-readable program instructions for performing various aspects of the present disclosure are loaded.

The computer-readable storage medium may be a tangible device that may hold and store instructions used by an instruction-executing device. For example, the computer-readable storage medium may be, but is not limited to, an electric storage device, a magnetic storage device, an optical storage device, an electromagnetic storage device, a semiconductor storage device, or any suitable combination of the foregoing. More specific examples (a non-exhaustive list) of the computer-readable storage medium include: a portable computer disk, a hard disk, a random access memory (RAM), a read-only memory (ROM), an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any appropriate combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium in each computing/processing device.

The computer program instructions for performing the operations of the present disclosure may be assembly instructions, instruction set architecture (ISA) instructions, machine instructions, machine-related instructions, microcode, firmware instructions, state setting data, or source or object code written in any combination of one or more programming languages, wherein the programming languages include object-oriented programming languages such as Smalltalk and C++, and conventional procedural programming languages such as the C language or similar programming languages. The computer-readable program instructions may be executed entirely on a user computer, partly on a user computer, as a stand-alone software package, partly on a user computer and partly on a remote computer, or entirely on a remote computer or server. In a case where a remote computer is involved, the remote computer can be connected to a user computer through any kind of networks, including a local area network (LAN) or a wide area network (WAN), or can be connected to an external computer (for example, connected through the Internet using an Internet service provider). In some implementations, an electronic circuit, for example, a programmable logic circuit, a field programmable gate array (FPGA), or a programmable logic array (PLA), is personalized by utilizing state information of the computer-readable program instructions, wherein the electronic circuit may execute the computer-readable program instructions so as to implement various aspects of the present disclosure.

Various aspects of the present disclosure are described herein with reference to flow charts and/or block diagrams of the method, the apparatus (system), and the computer program product according to implementations of the present disclosure. It should be understood that each block of the flow charts and/or the block diagrams and combinations of the blocks in the flow charts and/or the block diagrams may be implemented by the computer-readable program instructions.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means (e.g., specialized circuitry) for implementing the functions/actions specified in one or more blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various aspects of the functions/actions specified in one or more blocks in the flow charts and/or block diagrams.

The computer-readable program instructions may also be loaded to a computer, a further programmable data processing apparatus, or a further device, so that a series of operating steps may be performed on the computer, the further programmable data processing apparatus, or the further device to produce a computer-implemented process, such that the instructions executed on the computer, the further programmable data processing apparatus, or the further device may implement the functions/actions specified in one or more blocks in the flow charts and/or block diagrams.

The flow charts and block diagrams in the drawings illustrate the architectures, functions, and operations of possible implementations of the systems, methods, and computer program products according to a plurality of implementations of the present disclosure. In this regard, each block in the flow charts or block diagrams may represent a module, a program segment, or part of an instruction, the module, program segment, or part of an instruction including one or more executable instructions for implementing specified logical functions. In some alternative implementations, functions marked in the blocks may also occur in an order different from that marked in the accompanying drawings. For example, two successive blocks may actually be executed in parallel substantially, and sometimes they may also be executed in an inverse order, which depends on involved functions. It should be further noted that each block in the block diagrams and/or flow charts as well as a combination of blocks in the block diagrams and/or flow charts may be implemented using a special hardware-based system that executes specified functions or actions, or using a combination of special hardware and computer instructions.

Various implementations of the present disclosure have been described above. The above description is illustrative and not exhaustive, and is not limited to the various implementations disclosed. Numerous modifications and alterations are apparent to persons of ordinary skill in the art without departing from the scope and spirit of the illustrated implementations. The selection of terms as used herein is intended to best explain principles and practical applications of the various implementations or improvements to technologies on the market, or to enable other persons of ordinary skill in the art to understand the implementations disclosed here.

1. A method for managing data backups, comprising:
acquiring a plurality of tolerance time lengths respectively associated with a plurality of backup sessions, wherein a tolerance time length of the plurality of tolerance time lengths represents the length of time in which data loss is tolerated during a failure of a source storage device associated with a backup session of the plurality of backup sessions;
determining, based on the plurality of tolerance time lengths, a backup period for performing the plurality of backup sessions;
dividing the backup period into a plurality of time slices based on a predetermined time interval; and
allocating at least one time slice of the plurality of time slices to the backup session based on the tolerance time length.

2. The method according to claim 1, wherein allocating the at least one time slice of the plurality of time slices to the backup session includes: allocating a first time slice of the plurality of time slices to the backup session during the backup period based on an allocation state of the plurality of time slices.

3. The method according to claim 2, wherein allocating the first time slice to the backup session includes selecting the first time slice based on at least any one of:
in response to determining that the allocation state indicates that a given time slice of the plurality of time slices has not yet been allocated, selecting the given time slice as the first time slice; and
in response to determining that the allocation state indicates that all of the plurality of time slices have been allocated, selecting the first time slice from the plurality of time slices based on the numbers of times the plurality of time slices have been allocated.

4. The method according to claim 2, wherein allocating the at least one time slice of the plurality of time slices to the backup session further includes: in response to determining that the backup period is greater than the tolerance time length of the backup session,
allocating a second time slice of the plurality of time slices to the backup session during the backup period based on the allocation state of the plurality of time slices, the difference between the first time slice and the second time slice being no greater than the tolerance time length.

5. The method according to claim 1, wherein the time interval is determined based on at least any one of:
the minimum value of the plurality of tolerance time lengths;
the number of the plurality of backup sessions; and
the amount of backup data involved in the plurality of backup sessions.

6. The method according to claim 1, wherein determining the backup period includes:
determining the backup period based on a common multiple of the plurality of tolerance time lengths.

7. The method according to claim 1, further comprising: in response to determining that the backup period is a multiple of another tolerance time length associated with another backup session in the backup system,
determining the another tolerance time length associated with the another backup session; and
allocating at least one other time slice of the plurality of time slices to the another backup session based on the another tolerance time length.

8. The method according to claim 7, further comprising:
updating, in response to determining that the backup period is not a multiple of the another tolerance time length, the backup period based on the plurality of tolerance time lengths and the another tolerance time length;
dividing the updated backup period into a plurality of time slices based on the time interval; and
allocating at least one time slice of the plurality of time slices to the plurality of backup sessions and the another backup session, respectively, based on the plurality of tolerance time lengths and the another tolerance time length.

9. The method according to claim 1, further comprising: in response to determining that the backup session is terminated, releasing the at least one time slice that is allocated to the backup session.

10. The method according to claim 1, further comprising:
within the at least one time slice, performing the backup session; and
outside the at least one time slice, stopping the backup session.

11. An electronic device, comprising:
at least one processor;
a volatile memory; and
a memory coupled to the at least one processor, wherein the memory has instructions stored therein which, when executed by the at least one processor, cause the device to perform a method for managing data backups, the method including:
acquiring a plurality of tolerance time lengths respectively associated with a plurality of backup sessions, wherein a tolerance time length of the plurality of tolerance time lengths represents the length of time in which data loss is tolerated during a failure of a source storage device associated with a backup session of the plurality of backup sessions;
determining, based on the plurality of tolerance time lengths, a backup period for performing the plurality of backup sessions;
dividing the backup period into a plurality of time slices based on a predetermined time interval; and
allocating at least one time slice of the plurality of time slices to the backup session based on the tolerance time length.

12. The device according to claim 11, wherein allocating the at least one time slice of the plurality of time slices to the backup session includes: allocating a first time slice of the plurality of time slices to the backup session during the backup period based on an allocation state of the plurality of time slices.

13. The device according to claim 12, wherein allocating the first time slice to the backup session includes selecting the first time slice based on at least any one of:
in response to determining that the allocation state indicates that a given time slice of the plurality of time slices has not yet been allocated, selecting the given time slice as the first time slice; and
in response to determining that the allocation state indicates that all of the plurality of time slices have been allocated, selecting the first time slice from the plurality of time slices based on the numbers of times the plurality of time slices have been allocated.

14. The device according to claim 12, wherein allocating the at least one time slice of the plurality of time slices to the backup session further includes: in response to determining that the backup period is greater than the tolerance time length of the backup session,
allocating a second time slice of the plurality of time slices to the backup session during the backup period based on the allocation state of the plurality of time slices, the difference between the first time slice and the second time slice being no greater than the tolerance time length.

15. The device according to claim 11, wherein the time interval is determined based on at least any one of:
the minimum value of the plurality of tolerance time lengths;
the number of the plurality of backup sessions; and
the amount of backup data involved in the plurality of backup sessions.

16. The device according to claim 11, wherein determining the backup period includes:
determining the backup period based on a common multiple of the plurality of tolerance time lengths.

17. The device according to claim 11, wherein the method further includes: in response to determining that the backup period is a multiple of another tolerance time length associated with another backup session in the backup system,
determining the another tolerance time length associated with the another backup session; and
allocating at least one other time slice of the plurality of time slices to the another backup session based on the another tolerance time length.

18. The device according to claim 17, wherein the method further includes:
updating, in response to determining that the backup period is not a multiple of the another tolerance time length, the backup period based on the plurality of tolerance time lengths and the another tolerance time length;
dividing the updated backup period into a plurality of time slices based on the time interval; and
allocating at least one time slice of the plurality of time slices to the plurality of backup sessions and the another backup session, respectively, based on the plurality of tolerance time lengths and the another tolerance time length.

19. The device according to claim 18, wherein the method further includes at least any one of:
in response to determining that the backup session is terminated, releasing the at least one time slice that is allocated to the backup session;
within the at least one time slice, performing the backup session; and
outside the at least one time slice, stopping the backup session.

20. A computer program product having a non-transitory computer readable medium which stores a set of instructions to manage data backups; the set of instructions, when carried out by computerized circuitry, causing the computerized circuitry to perform a method of:
acquiring a plurality of tolerance time lengths respectively associated with a plurality of backup sessions, wherein a tolerance time length of the plurality of tolerance time lengths represents the length of time in which data loss is tolerated during a failure of a source storage device associated with a respective backup session of the plurality of backup sessions;
determining, based on the plurality of tolerance time lengths, a backup period for performing the plurality of backup sessions;
dividing the backup period into a plurality of time slices based on a predetermined time interval; and
allocating at least one time slice of the plurality of time slices to the backup session based on the tolerance time length.
